(19) United States
(12) Patent Application Publication
(10) Pub. No.: US 2005/0057754 A1
(43) Pub. Date: Mar. 17, 2005

(54) Measurement of thin film properties using plasmons

(76) Inventors: David E. A. Smith, San Mateo, CA (US); Behzad Imani, Hillsborough, CA (US); Nader Shamma, Cupertino, CA (US); Patrick M. Maxton, San Jose, CA (US); Mark Luitzen Brongersma, Redwood City, CA (US)

Correspondence Address: MORRISON & FOERSTER LLP, 755 PAGE MILL RD, PALO ALTO, CA, 94304-1018, US

(21) Appl. No.: 10/888,555

(22) Filed: Jul. 8, 2004

Related U.S. Application Data
(60) Provisional application No. 60/485,928, filed on Jul. 8, 2003.

(51) Int. Cl. G01N 21/55

(52) U.S. Cl. 356/445

(57) ABSTRACT

Properties of thin electrically conductive films are measured using plasmons. The plasmons are excited in the film using a suitable pump beam of electromagnetic radiation. A probe beam of electromagnetic radiation is directed onto the excited film and is diffracted thereby and the diffracted beam is detected. The detected signal indicates film properties such as thickness and surface roughness.

### CROSS REFERENCE TO RELATED APPLICATION

This application claims priority to provisional patent application U.S. 60/485,928 filed Jul. 8, 2003 and incorporated herein by reference in its entirety.

### FIELD OF THE INVENTION

This invention related to measurement of conductive of thin film properties, such as done in the semiconductor processing field.

### BACKGROUND

Measurement of properties of thin films is a well known problem. One aspect is measurement of properties of thin metallic films such as in integrated circuits or other semiconductor structures, where such films serve as electrically conductive layers or parts of semiconductor devices, preferably in a non-destructive fashion. Present methods are generally too slow or imprecise, especially for very thin films.

### SUMMARY

As described here, induced plasmons are used to measure properties such as surface roughness of thin film. Plasmons are a well-known thin film phenomenon. See also provisional U.S. 60/425,097 Brongersma, and provisional U.S. 60/477,275 Imani et al, mentioned below and herewith incorporated by reference in their entireties.

### DETAILED DESCRIPTION

This disclosure is directed to measurement of thin film properties (e.g., surface roughness). Surface roughness can be measured by comparing a diffracted plasmon signal with the signal detected with the plasmon excitation beams blocked. This background scattering will be the result of stray light and roughness coupled plasmons. Roughness measurement in combination with thickness determination via plasmon detection is new. Surface roughness can also be determined and then corrected for in the system to produce more accurate fits to film thickness.

The plasmon measurement system may be either a “near-field” apparatus, as described in provisional U.S. 60/425,097 Brongersma, or a “far-field” apparatus, as described in provisional U.S. 60/477,275 Imani et al. This method and apparatus are capable of measuring thickness of thin conductive films including but not limited to metals such as Cu, Ag, Al, Au, and Ti deposited on semiconductor substrates including but not limited to Si, SiGe, GaAs, InP, and on various types of glass substrates such as quartz and low-expansion glass used in semiconductor, telecommunications, and flat-panel display applications.

The plasmon measurement system (either a near-field apparatus, or a far-field apparatus) and method are capable of measuring thickness of thin conductive films in a variety of physical environments including but not limited to ultra high vacuum (UHV) that may be present in physical vapor deposition (PVD) tools used for copper (Cu) deposition on semiconductor wafers for integrated circuit applications.

For in-situ measurements, preferably, the plasmon subsystem and the PVD tool are combined into one apparatus and arranged to be able to take measurements during the deposition of the conductive thin film, such as Cu, under UHV conditions.

For in-line measurements, preferably, the plasmon subsystem and the PVD tool are combined into one apparatus and arranged to be able to take measurements under room temperature and pressure (RTP) using the transport and wafer handling subsystems of the PVD tool.

The apparatus includes a stage that allows for site-by-site leveling to minimize focus errors (the biggest contributor to the error budget) and also the extraction of tilt data so that tilt errors can be processed out of the data without physically leveling the film and its substrate, i.e. one monitors the zero order diffraction position to track tilt.

A measurement device that includes both an opto-acoustic film measurement subsystem and a plasmon film measurement subsystem for determining the characteristics of a sample is provided. Opto-acoustic film thickness measurement is a method for determining the thickness of a thin sample, such as a film on a semiconductor wafer. The method includes the step of exciting time-dependent acoustic waveguide modes in the sample with an excitation radiation field. The acoustic waveguide modes are detected by diffracting probe radiation off a ripple morphology induced on the sample's surface by the acoustic waveguide modes. The diffracted probe radiation is then analyzed to measure phase velocities or frequencies of the acoustic waveguide modes. A thickness of the thin sample is determined by comparing the measured phase velocities or frequencies to the phase velocities or frequencies calculated from a mathematical model. The method is described, for example, in U.S. Pat. No. 5,812,261(Method and device for measuring the thickness of opaque and transparent films, incorporated herein by reference in its entirety. The present plasmon measurement subsystem may be either a near-field apparatus, or a far-field apparatus. Preferably, the plasmon and the opto-acoustic subsystems are combined into one apparatus and arranged to be able to take measurements at the same location on the wafer.

Opto-acoustic film measurement is capable of measuring thicker films than can be measured with a plasmon measurement system. By combining the two methods in a single apparatus, the total apparatus is capable of measuring a wider range of sample types. This makes it possible, for example, for a single apparatus to measure thin layers of copper deposited on a wafer by physical vapor deposition and then to measure the thickness of a thicker copper film deposited on the wafer by a subsequent electro-plating process.

For samples having films that both subsystems can measure, a processor receives data from the plasmon and opto-acoustic subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the opto-acoustic subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

A measurement device that includes both a grazing incidence X-ray reflectance film measurement (also called X-ray reflectometry) subsystem and a plasmon film measurement subsystem for determining the characteristics of a sample is also provided. Grazing incidence X-ray reflectance (XRR) film thickness measurement is a well-known method for determining the thickness of a thin sample that provides a way to analyze the thickness interface roughness and density of thin-films disposed on semiconductor substrates. For example, U.S. Pat. No. 5,619,548 and PCT Publication W01/71325 A2, both, incorporated herein by reference in their entireties, discuss different aspects of XRR systems. The plasmon measurement subsystem may be either a near-field apparatus, or a far-field apparatus. Preferably, the plasmon and the grazing-incidence X-ray reflectance subsystems are combined into one apparatus and arranged to be able to take measurements at the same location on the wafer.

Grazing incidence X-ray subsystems can be very accurate, but are typically much slower than plasmon measurement systems. Slow measurement can be overcome by using plasmon metal thickness metrology in combination with a grazing incidence X-ray reflectance subsystem in an apparatus where the X-ray subsystem is used to calibrate and improve the total system's accuracy. The slower X-ray signal is used to measure a few points on the wafer that are also measured by plasmons. Plasmon measurements can then be made more rapidly elsewhere on the wafer and referenced to the sites measured by both plasmons and X-rays so that the many measurements are made in a short time that are more accurate because of the use of the X-ray measurement reference.

In an alternative use for this combination X-ray and plasmon apparatus, a processor receives data from the plasmon and X-ray subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the X-ray subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

A measurement device that includes both a spectroscopic ellipsometer film measurement subsystem and a plasmon film measurement subsystem for determining the characteristics of a sample is also provided. Spectroscopic Ellipsometry (SE) is a well-known method for determining the thickness and optical properties of film layers in a stack of thin films. It is described, among other places in R. M. A. Azzam and N. M. Bashara, Ellipsometry and Polarized Light (North-Holland, Amsterdam, The Netherlands, 1977) Chapter 6 and in U.S. Pat. No. 5,608,526 Focused beam spectroscopic ellipsometry method and system, incorporated herein by reference in its entirety. The plasmon measurement subsystem may be either a near-field apparatus, or a far-field apparatus. Preferably, the plasmon and the SE subsystems are combined into one apparatus and arranged to be able to take measurements at the same location on the wafer.

Plasmon measurement is capable of measuring conductive films than cannot be measured with an SE measurement system. By combining the two methods in a single apparatus, the total apparatus is capable of measuring a wider variety of sample types, including both conductive and dielectric films. This makes it possible, for example, for a single apparatus to measure copper deposited on a wafer and to measure the thickness of a dielectric film deposited on the wafer in a different processing step.

When useful data is acquired from subsystems, a processor receives data from the plasmon and SE subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the SE subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

A measurement device that includes both a beam profile ellipsometer (BPE) film measurement subsystem and a plasmon film measurement subsystem for determining the characteristics of a sample is also provided. Beam Profile Ellipsometry (BPE) is described in U.S. Pat. No. 5,181,080 Method and apparatus for evaluating the thickness of thin films, incorporated herein by reference in its entirety. BPE evaluates the thickness of a very thin film (typically less than 10 nm) by measuring the phase shift of a focused laser beam. For sufficiently thin films BPE is functionally equivalent to classical ellipsometry. The plasmon measurement subsystem may be either a near-field apparatus, or a far-field apparatus. Preferably, the plasmon and the BPE subsystems are combined into one apparatus and arranged to be able to take measurements at the same location on the wafer.

Plasmon measurement is capable of measuring conductive films than cannot be measured with an BPE measurement system. By combining the two methods in a single apparatus, the total apparatus is capable of measuring a wider variety of sample types, including both conductive and dielectric films. This makes it possible, for example, for a single apparatus to measure copper deposited on a wafer and to measure the thickness of a dielectric film deposited on the wafer in a different processing step.

When useful data is acquired from subsystems, a processor receives data from the plasmon and BPE subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the BPE subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

A measurement device that includes both a beam profile reflectometer (BPR) film measurement subsystem and a plasmon film measurement subsystem for determining the characteristics of a sample is also provided. A Beam Profile Reflectometer (BPR) is described in U.S. Pat. No. 4,999,014 Method and apparatus for measuring thickness of thin films, incorporated herein by reference in its entirety. A BPR apparatus uses a probe beam of radiation focused normal to the surface of the sample by a high numerical aperture lens. The high numerical aperture lens provides a large spread of angles of incidence of the rays within the incident focused beam. A detector measures the intensity across the reflected probe beam as a function of the angle of incidence with respect to the surface of the substrate of various rays within the focused incident probe beam. A processor functions to derive the thickness of the thin film layer based on these angular dependent intensity measurements. This result is achieved by using the angular dependent intensity measurements to solve the layer thickness using variations of the Fresnel equations. The plasmon measurement subsystem may be either a near-field apparatus, or a far-field apparatus. Preferably, the plasmon and the BPR subsystems are combined into one apparatus and arranged to be able to take measurements at the same location on the wafer.

Plasmon measurement is capable of measuring conductive films than cannot be measured with an BPR measurement system. By combining the two methods in a single apparatus, the total apparatus is capable of measuring a wider variety of sample types, including both conductive and dielectric films. This makes it possible, for example, for a single apparatus to measure copper deposited on a wafer and to measure the thickness of a dielectric film deposited on the wafer in a different processing step.

When useful data is acquired from subsystems, a processor receives data from the plasmon and BPR subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the BPR subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

A measurement device that includes both a single-wavelength ellipsometer (SWE) film measurement subsystem and a plasmon film measurement subsystem for determining the characteristics of a sample is also provided. Ellipsometry is a well-known method for determining the thickness and optical properties of film layers in a stack of thin films. It is described, among other places in R. M. A. Azzam and N. M. Bashara, Ellipsometry and Polarized Light (North-Holland, Amsterdam, The Netherlands, 1977). The plasmon measurement subsystem may be either a near-field apparatus, or a far-field apparatus. Preferably, the plasmon and the SWE subsystems are combined into one apparatus and arranged to be able to take measurements at the same location on the wafer.

A processor receives data from the plasmon and SWE subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the SWE subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

In addition, an SWE apparatus using a light generator that generates a quasi-monochromatic beam of light having a known wavelength and a known polarization can be used to measure a reference sample that will also be measured by the plasmon subsystem. Data from both the SWE subsystem and the plasmon subsystem is sent to a processor that calibrates the plasmon subsystem by comparing the measured optical parameter from the plasmon subsystem to the determined optical property from the reference SWE.

A measurement device that includes both a dual-beam, normal-incidence reflectance spectrometer (DBS) film measurement subsystem and a plasmon film measurement subsystem for determining the characteristics of a sample is also provided. Reflectance spectrometry is a well-known method for determining the thickness and optical properties of film layers in a stack of thin films. A polychromatic light beam is incident on the sample surface. Different wavelengths of light are reflected from the sample with different intensities because of the interference they undergo between the film layers on the sample. A detector measures the reflected intensity as a function of the wavelength of reflected light and compares it with the intensity as a function of wavelength of a second reference beam that is delivered from the light source to the detector without having been reflected by the sample. Comparison of the intensities determines the light attenuation of the reflected beam as a function of wavelength. A processor functions to derive the thickness of the sample thin film layer based on these wavelength dependent intensity measurements. This result is achieved by using the wavelength dependent intensity measurements to solve for the layer thickness using variations of the Fresnel equations. The plasmon measurement subsystem may be either a “near-field” apparatus, or a “far-field” apparatus. Preferably, the plasmon and the DBS subsystems are combined into one apparatus and arranged to be able to take measurements at the same location on the wafer.

Plasmon measurement is capable of measuring conductive films that cannot be measured with an DBS measurement system. By combining the two methods in a single apparatus, the total apparatus is capable of measuring a wider variety of sample types, including both conductive and dielectric films. This makes it possible, for example, for a single apparatus to measure copper deposited on a wafer and to measure the thickness of a dielectric film deposited on the wafer in a different processing step.

When useful data is acquired from the subsystems, a processor receives data from the plasmon and DBS subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the DBS subsystem and from the plasmon subsystem, sample properties including electrical conductivity, optical index of refraction, optical extinction coefficient, film-layer thickness, film-interface roughness, film density, film composition, and film crystal-grain structure can be more accurately determined.

A measurement device that includes both a sheet-resistance measurement subsystem and a plasmon metal metrology subsystem for determining the characteristics of a sample is also provided. An automatic sheet resistance mapping apparatus for semiconductor wafers has been described in U.S. Pat. No. 4,703,252 Apparatus and methods for resistivity testing, incorporated herein by reference in its entirety. This apparatus is capable of taking high accuracy, multiple test readings of sheet resistance on semiconductor wafers. The plasmon measurement subsystem may be either a near-field apparatus, or a far-field apparatus. Preferably, the plasmon and the sheet-resistance measurement subsystems are combined into one apparatus and arranged to be able to take measurements at the same location on the wafer.

Sheet-resistance measurement subsystems can measure films that are thicker than those that can be measured with plasmons, but because they use probes that contact and can damage the wafer surface they are not suitable for some measurements. By combining the two methods in a single apparatus, the total apparatus is capable of measuring a wider range of sample types. This makes it possible, for example, for a single apparatus to use plasmons to measure thin layers of copper deposited on a wafer by physical vapor deposition and then to use sheet resistance to measure the a thicker film deposited on the wafer by a subsequent electro-plating process.

On samples where both methods may be applied, a processor receives data from the plasmon and sheet-resistance measurement subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the sheet-resistance measurement subsystem and from the plasmon subsystem, sample properties including electrical conductivity, optical index of refraction, optical extinction coefficient, film-layer thickness film-interface roughness, film density, film composition, and film crystal-grain structure can be more accurately determined.

A measurement device that includes both an X-ray fluorescence subsystem and a plasmon metal thickness metrology subsystem for determining the characteristics of a sample is also provided. X-ray fluorescence (XRF) analyzers are well known in the art, for determining the elemental composition of a sample. XRF analyzers generally include an X-ray source, which irradiates the sample, and an X-ray detector, for detecting the X-ray fluorescence emitted by the sample in response to the irradiation. Each element in the sample emits X-ray fluorescence in energy bands that are characteristic of the element. The detected X-ray fluorescence is analyzed to find the energies or, equivalently, the wavelengths of the detected photons, and the qualitative and/or quantitative composition of the sample is determined based on this analysis. Quantitative composition information can be combined with other information to determine properties such as the thickness of a metal layer on a sample wafer or the layer's conductivity. X-ray subsystems that might be employed in this apparatus include those described in U.S. Pat. No. 6,108,398 (X-ray microfluorescence analyzer), U.S. Pat. No. 6,041,095 X-ray fluorescence analyzer, U.S. Pat. No. 6,381,303 X-ray microanalyzer for thin films, U.S. Pat. No. 6,453,002 Differential measurement of X-ray microfluorescence, or U.S. Pat. No. 6,556,652 Measurement of critical dimensions using X-rays, all incorporated herein by reference in their entireties. The plasmon measurement subsystem may be either a near-field apparatus, or a far-field apparatus. Preferably, the plasmon and the X-ray fluorescence subsystems are combined into one apparatus and arranged to be able to take measurements at the same location on the wafer.

A processor receives data from the plasmon and X-ray subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the X-ray subsystem and from the plasmon subsystem, sample properties including electrical conductivity, optical index of refraction, optical extinction coefficient, film-layer thickness film-interface roughness, film density, film composition, and film crystal-grain structure can be more accurately determined.

A measurement device that includes both a photo-acoustic film measurement subsystem and a plasmon film measurement subsystem for determining the characteristics of a sample is also provided. Photo-acoustic film measurement, described in U.S. Pat. No. 4,710,030 Optical generator and detector of stress pulses, incorporated herein by reference in its entirety, optically induces stress pulses in a film and optically measures the pulses after they have traveled through the film to measure the thickness and other properties of the film's layers. The plasmon measurement subsystem may be either a near-field apparatus, or a far-field apparatus. Preferably, the plasmon and the photo-acoustic subsystems are combined into one apparatus and arranged to be able to take measurements at the same location on the wafer.

Photo-acoustic film measurement is capable of measuring thicker films than can be measured with a plasmon measurement system. By combining the two methods in a single apparatus, the total apparatus is capable of measuring a wider range of sample types. This makes it possible, for example, for a single apparatus to measure thin layers of copper deposited on a wafer by physical vapor deposition and then to measure the thickness of a thicker film deposited on the wafer by a subsequent electro-plating process.

For samples having films that both subsystems can measure, a processor receives data from the plasmon and photo-acoustic subsystems and combines that data to resolve ambiguities about the characteristics of the sample. The processor can be part of the apparatus or separate, as long as the measurement data is transferred to the processor. The processor evolves models of theoretical data, which are compared to the measured data, and a “best fit” solution is provided as the result. By using the combination of data from the opto-acoustic subsystem and from the plasmon subsystem, sample properties including electrical conductivity, optical index of refraction, optical extinction coefficient, film-layer thickness, film-interface roughness, film-interface mechanical coupling, film density, film composition, and film crystal-grain structure can be more accurately determined.

Other aspects in accordance with the invention are as follows.

One can provide detection of one of the excitation beams using a position sensitive detector for independent autofocus of the excitation beam.

One can use s-polarized (surface plasmon forbidden) probe beam angular spectra to normalize the p-polarized probe beam spectra.

One can measure oxidation of metals and the presence of impurities (from, e.g., a plating bath). Oxidation of a certain thickness of Cu leads to a well-defined change in the angle dependent reflectivity. It therefore is possible to extract the oxidized layer thickness from angle dependent reflectivity curves. The presence of the impurities will have its largest impact on the imaginary part of the dielectric constant. This is due to the inelastic scattering events from electrons of these impurities.

One can perform measurements with a probe beam at various wavelengths of the probe beam. Angle dependent reflectivity curves taken at different wavelengths give complementary information, reducing the error in the film thickness derived from an angle dependent reflectivity measurement at one wavelength.

One can use the second harmonic of the excitation pulse as the probe beam. This may have significant timing advantages. This involves using only one beam source for both the probe and excitation beam, but these two beams have two different wavelengths due to a doubler.

One can use a resonant pumping scheme for the surface acoustic wave to increase the amplitude of the surface acoustic wave with less peak power of the pulsed excitation laser.

One can use the optical transfer matrix method for fast and data analysis (by suitable software). The transfer matrix method is ideally suited for determining the reflectivity curves as a function of angle for layer systems. It is based on the Maxwell equations and uses the dielectric properties of the different layers as input. No other assumptions are made and there are no free parameters.

One can use the both the zeroth and higher order diffraction maxima of the probe beam from the SAW grating to obtain data for the thickness of a metal film.

One can use different diffraction gratings than the most common line grating. One can use special lenses to induce other than linear diffraction patterns. For example, one could induce gratings with circular symmetry. The scattering of light from a probe beam from such a grating can also cause the excitation of plasmon waves and provide information on the dimensions of a Cu film or structure.

This disclosure is illustrative but not limiting; further modifications will be apparent to one skilled in the art in light of this disclosure and are intended to fall within the scope of the appended claims.

1. Method to measure properties of a conductive film, comprising the acts of:
directing a first beam of radiation onto the film thereby to excite plasmons in the film;
directing a second beam of radiation onto the excited film; and
detecting a diffraction of the second beam from the excited film.

2. The method of claim 1, wherein the detecting is near field or far field detecting.

3. The method of claim 1, further comprising in the detecting, correcting for errors caused by a tilt of the film.

4. The method of claim 1, further comprising comparing a detected signal from the film with and without the plasmons being excited.

5. The method of claim 1, further comprising determining properties of the film from the detected second beam, the properties being at least one of surface roughness, thickness, electrical conductivity, index of refraction, extinction coefficient, density, composition, and crystal grain structure.

6. The method of claim 1, further comprising measuring properties of the beam using a method selected from the group consisting of: opto-acoustic measurement; X-ray reflectance measurement; spectroscopic ellipsometry, beam profile ellipsometry, single wavelength ellipsometry, dual beam normal-incidence reflection spectrometry, sheet-resistance measurement; X-ray fluorescence measurement; and photo-acoustical measurement.

7. The method of claim 1, further comprising detecting the first beam.

8. The method of claim 1, wherein the second beam is polarized.

9. The method of claim 1, wherein the first beam is applied to the film at a plurality of wavelengths, each wavelength being detected by the second beam.

10. The method of claim 1, wherein the second beam is a harmonic of the first beam.

11. The method of claim 1, wherein the first beam resonantly excites the film.

12. Apparatus for measuring properties of a conductive thin film, comprising:
a support for the film;
a source of a first radiation beam adapted to direct the first beam onto the film, thereby to excite plasmons therein;
a source of a second radiation beam adapted to direct the second beam onto the film; and
a detector located to detect the second beam as diffracted from the film.

13. The apparatus of claim 12, wherein the detector is one of a near field or far field detector.

14. The apparatus of claim 12, wherein the detector corrects for errors caused by a tilt of the film.

15. The apparatus of claim 12, wherein the detector compares a signal from the film with and without the plasmons being excited by the first beam.

16. The apparatus of claim 12, wherein the measured properties include at least one of surface roughness, thickness, electrical conductivity, index of refraction, extinction coefficient, density, composition, and crystal grain structure.

17. The apparatus of claim 12, further comprising additional apparatus selected from the group consisting of: opto-acoustic measurement apparatus, X-ray reflectance measurement apparatus, spectroscopic ellipsometry apparatus, beam profile ellipsometry apparatus, beam profile reflectometer measurement apparatus, single wavelength ellipsometer measurement apparatus, dual beam normal-incidence reflectance spectrometer apparatus, sheet-resistance measurement apparatus, X-ray fluorescence measurement apparatus, and photo-acoustic measurement apparatus, wherein the additional apparatus is located to measure properties of the film on the support.

18. The apparatus of claim 12, wherein the detector detects the first beam.

19. The apparatus of claim 12, wherein the second beam is polarized.

20. The apparatus of claim 12, wherein the second beam is at one of a plurality of wavelengths, each wavelength being detectable by the detector.

21. The apparatus of claim 12, wherein the second beam is at a wavelength that is a harmonic of the wavelength of the first beam.

22. The apparatus of claim 12, wherein the first beam resonantly excites the film.
